(19) United States
(12) Patent Application Publication
(10) Pub. No.: US 2026/0368474 A1
(43) Pub. Date: Nov. 19, 2026

(54) Quantization of Weights for Analog Compute Modules having Fabrication Process Variation

(71) Applicant: Micron Technology, Inc., Boise, ID (US)

(72) Inventors: Febin Sunny, Folsom, CA (US); Poorna Kale, Folsom, CA (US)

(21) Appl. No.: 18/733,726

(22) Filed: Jun. 4, 2024

Related U.S. Application Data
(60) Provisional application No. 63/507,242, filed on Jun. 9, 2023.

(51) Int. Cl. G06N 3/04; G06N 3/065; G06N 3/09

(52) U.S. Cl. CPC G06N 3/04; G06N 3/065; G06N 3/09

(57) ABSTRACT

Quantization of an artificial neural network model for implementation via memristors having fabrication process variations. For example, a nominal conductance voltage curve of the memristors in a crossbar array can be measured without measuring respective curves of individual memristors. A programming voltage list having a predetermined number of programming voltages can be identified using the nominal conductance voltage curve. A quantized model can be generated based on replacing weights in the artificial neural network model with indexes identifying programming voltages in the programming voltage list. The memristors can be programmed according to the indexes to implement the weights. After evaluating an accuracy level of the quantized model based on the memristors being programmed according to the indexes, the programming voltage list can be adjusted to increase the accuracy level.

### RELATED APPLICATIONS

The present application claims priority to Prov. U.S. Pat. App. Ser. No. 63/507,242 filed Jun. 9, 2023, the entire disclosures of which application are hereby incorporated herein by reference.

### TECHNICAL FIELD

At least some embodiments disclosed herein relate to acceleration of multiplication and accumulation operations using memory sub-systems.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

Many techniques have been developed to accelerate the computations of multiplication and accumulation. For example, multiple sets of logic circuits can be configured in arrays to perform multiplications and accumulations in parallel to accelerate multiplication and accumulation operations. For example, photonic accelerators have been developed to use phenomenon in optical domain to obtain computing results corresponding to multiplication and accumulation. For example, a memory sub-system can use a memristor crossbar or array to accelerate multiplication and accumulation operations in electrical domain.

### BRIEF DESCRIPTION OF THE DRAWINGS

The embodiments are illustrated by way of example and not limitation in the figures of the accompanying drawings in which like references indicate similar elements.

FIG. 1 shows a technique to quantize the weights of an artificial neural network model based on a set of representative weights having a nonlinear distribution in the weight space according to one embodiment.

FIG. 2 illustrates the optimization of a quantized model having a predetermined number of representative weights according to one embodiment.

FIG. 3 shows the mapping between representative weights and voltages to program a memristor to have the representative weights of a nonlinear distribution according to one embodiment.

FIG. 4 shows the programming of a memristor crossbar array to implement multiplication and accumulation operations of a quantized model according to one embodiment.

FIG. 5 shows a memristor crossbar array of an analog compute module to implement multiplication and accumulation operations of a quantized model according to one embodiment.

FIG. 6 shows a technique to account for fabrication process variations in memristors using a nominal conductance voltage curve in quantization of weights according to one embodiment.

FIG. 7 shows measuring a nominal conductance voltage curve of a memristor crossbar array according to one embodiment.

FIG. 8 shows another method of measuring a nominal conductance voltage curve of a memristor crossbar array according to one embodiment.

FIG. 9 shows the optimization of a quantized model to account for fabrication process variations according to one embodiment.

FIG. 10 shows a method of quantization of an artificial neural network model for implementation in an analog compute module having fabrication process variations according to one embodiment.

### DETAILED DESCRIPTION

At least some embodiments disclosed herein provide techniques of nonlinear quantization of weights implemented using conductance of memristors of an analog compute module to accelerate operations of multiplication and accumulation of the weights (e.g., in an artificial neural network). The memristors can have fabrication process variations. The quantization technique can be configured to minimize the effects of the fabrication process variations as random noises.

In some applications, it can be desirable to perform a quantization operation of replacing a large number of different weights used in an artificial neural network (ANN) model with a small, predetermined number of representative weights. When being limited to the use of weights selected from the small set of representative weights, the quantized version of the artificial neural network (ANN) model can use space for storage and less communication bandwidth for transmission and can, in some implementations, simplify the computations involving the weights.

During the quantization of the original weights of an artificial neural network (ANN) model, the entire set of different weights used in the model can be replaced with, and thus approximated by, the closest weights selected from a small set of representative weights. Each original weight in the model can be rounded to a closest representative weight in the representative weight set. The rounding of original weights to their closest representative weights introduces errors and thus inaccuracy.

In at least some embodiments disclosed herein, representative weights of a nonlinear distribution are used to quantize the weights of an artificial neural network (ANN) model. The representative weights are unevenly distributed within the entire range of possible weights in the weight space. Thus, the gaps between adjacent representative weights can be non-uniform.

The weights of a typical artificial neural network (ANN) model have an uneven distribution of incident rates. Typically, there are more weights in the middle range than in the lower ranger and in the upper range. However, the accuracy of the weights in the lower range and the upper range can be more important to the overall accuracy of the artificial neural network (ANN) model than the weights in the middle range.

For example, more representative weights can be allocated to the lower weight range and the upper weight range than to the middle weight range. For example, representative weights can be configured to be more densely populated in the lower and upper weight ranges than in the middle weight range. For example, the gaps between adjacent representative weights can be bigger in the middle range than in the lower and upper ranges.

As a result, the accuracy in quantization of weights can be higher for the lower and upper ranges than for the middle range; and the rounding errors in approximating original weights of the artificial neural network (ANN) model using representative weights from the small weight set can be lower in the lower and upper weight ranges than in the middle weight range.

Optionally, the selection of the representative weights for quantization can be adjusted to change the accuracy level of the quantized model; and the changes can be explored to arrive at a set of representative weights that improve or optimize the overall accuracy of the quantized model.

When a number of representative weights are evenly spaced, the rounding errors resulting from the use these representative weights can be substantially evenly distributed across the range of these representative weights. The rounding errors are limited by the gap between the adjacent representative weights.

Since the weights in the lower and upper ranges of weights can be more important to the overall accuracy of the artificial neural network (ANN) model, the representative weights can be configured to have a smaller gap in the lower and upper ranges to reduce the rounding errors for quantization of weights in the lower and upper ranges. In contrast, the representative weights can be configured to have a larger gap in the middle range to allow larger rounding errors for quantization of weights in the middle range than for the lower and upper ranges.

For example, the weight range of the artificial neural network (ANN) model can be divided into a lower range, a middle range, and an upper range. A lower threshold can be selected to separate the lower range from the middle range; and an upper threshold can be selected to separate the middle range from the upper range. A predetermined number of representative weights can be allocated for even distribution within the middle range; and the remaining representative weights can be allocated for even distribution within the upper and lower range. Thus, the size of gaps between adjacent representative weights in the middle range is generally different from the size of gaps between adjacent representative weights in the lower and upper ranges. Adjusting the thresholds can change the gap sizes and thus the ratio between the gap size for the middle region and the gap size for the lower and upper ranges. The ratio is representative of the accuracy difference in quantization for the middle range and for the lower and upper ranges. The adjustment of the ratio can be used in searching for a set of representative weights for quantization that can improve or optimize overall accuracy level for the quantized model.

In general, the optimization of the quantized model does not have to be limited to a particular pattern of organizing the representative weights. For example, it is not necessary to evenly distribute, within the middle region, the number of representative weights allocated to the middle region. For example, it is not necessary to maintain a same size of gaps between adjacent representative weights for the lower range and for the upper range. Optionally, restrictions in implementing the weights in a compute module (e.g., via conductance of memristors) can be included in selectively positioning the representative weights.

After the weight quantization, the weights in the quantized model can be represented using the indexes of the representative weights as in a representative weight list. For example, when eight (8) representative weights are used to quantize the artificial neural network (ANN) model, each weight in the model can be converted into a three-bit index of a closest representative weight among the eight (8) representative weights. When a nonlinear distribution of representative weights is used, the weight indexes cannot be converted to the representative weights via a linear mapping. A look up table can be used to determine the representative weight identified via a weight index.

When the multiplication and accumulation operations of the quantized model are accelerated via an analog compute module implemented using a memristor crossbar, the weights can be represented using the conductance of the memristors.

For example, a linear mapping between weight and memristor conductance can be used to implement the weights via conductance of memristors. Since conductance of memristors is configured to be proportional to the respective weights, multiplication of the weights can be proportional to multiplication of memristor conductance, as in the relation between current going through a memristor and the conductance of the memristor. The current is equal to the multiplication of the memristor conductance by an input voltage applied to the memristor.

A memristor can have a conductance voltage curve that identifies the relation between a voltage level applied to program the memristor and the resulting conductance of the memristor. Thus, for each conductance value used to implement a representative weight, a programming voltage can be determined from the conductance voltage curve. Therefore, the list of representative weights can have a list of programming voltages for their implementation via the memristor. An index to select a weight from the weight list can also be used to select a programming voltage to implement the weight via programming the conductance of the memristor.

In some implementations, the use of programming voltages to achieve desirable conductance can have challenges in certain regions of conductance and/or programming voltages. For example, selectable programming voltages can be limited; and such restriction can affect the selection of representative weights for quantization of the artificial neural network model. For example, programming voltages that can be generated to program a memristor can have a limited resolution (e.g., based on steps of incremental voltages that can be generated, resolution of digital to analog converters to apply programming voltages). Thus, different programming voltages can have different accuracy levels in producing desirable memristor conductance. The optimization of the quantized model can be performed with such restrictions and/or with optimization to reduce or minimize such inaccuracy.

The overall accuracy of the quantized model can be evaluated based on a set of test inputs. For example, the output of the artificial neural network (ANN) model responsive to a test input can be compared with the corresponding output of the quantized model to evaluate the accuracy of the quantized model. The selection of the representative weights for quantization can be adjusted to minimize the differences between the outputs of the artificial neural network (ANN) model and the outputs of the quantized model for the set of test inputs.

Optionally, the outputs of the quantized model can be generated from implementing the multiplication and accumulation of the weights through the memristors in the analog compute module to account for not only the errors in weight quantization but also the errors in weight implementation through memristor conductance. The outputs of the artificial neural network (ANN) model can be computed using alternative accelerators (e.g., implemented via logic circuits) or using microprocessors (e.g., graphical processing units) to achieve high accuracy.

Optionally, a set of training data can be used to further train the quantized model to improve the accuracy of the quantized model. In some implementations, the training of the quantized model is configured to both identify weights for artificial neurons, limited to a set of representative weights, and identify the representative weights in the set, through reduction of the errors in making predictions according to the training data.

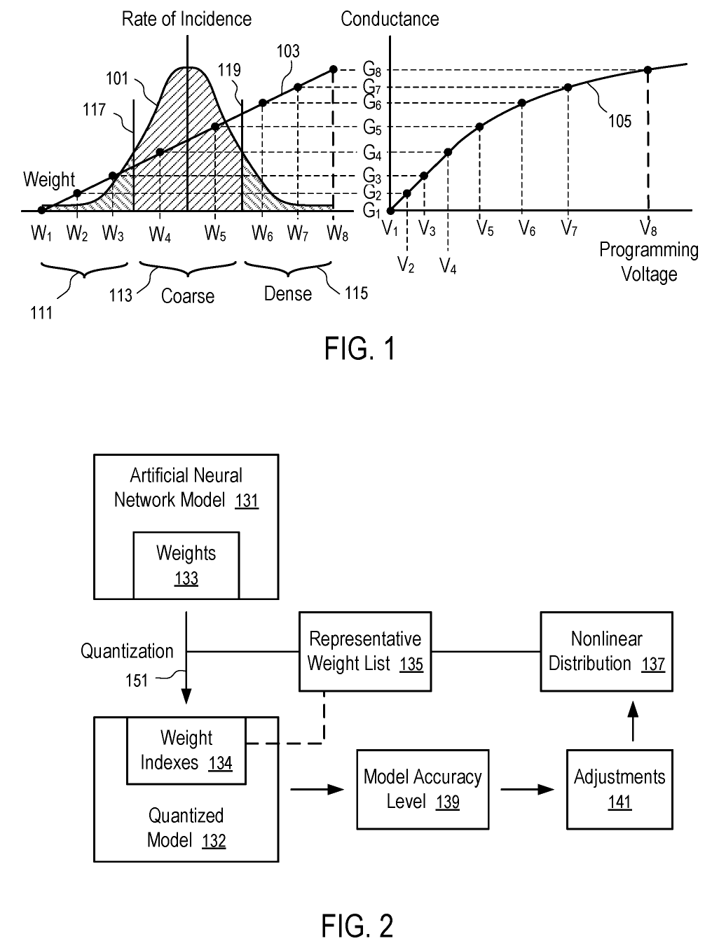

FIG. 1 shows a technique to quantize the weights of an artificial neural network model based on a set of representative weights having a nonlinear distribution in the weight space according to one embodiment.

In FIG. 1, the weights of the artificial neural network (ANN) model has a distribution curve 101 of rate of incident. A typical weight (e.g., W4 or W5) in a middle range has a high rate of incidence. A typical weight (e.g., W2 or W7) in the lower and upper ranges has a low rate of incident.

A lower threshold 117 and a higher threshold 119 can be used to divide the ranges of weights into three regions. A lower range 111 contains the weights smaller than the lower threshold 117; an upper range 115 contains the weights larger than the higher threshold 119; and a middle range 113 contains the weights that are between the lower threshold 117 and the higher threshold 119.

FIG. 1 illustrates the use of eight representative weights W1 to W8 for the quantization of the weights having the distribution curve 101. In general, more or less representative weights can be used. Thus, the technique is not limited to the use of a particular number of representative weights in quantization.

Since the accuracy of the weights in the lower range 111 and the upper ranges 115 are generally more important, more representative weights are allocated and distributed to the lower range 111 and the upper range 115 than to the middle range 113.

The inter-weight gaps between the adjacent representative weights (e.g., W5 – W4) in the middle range 113 are configured to be larger than the inter-weight gaps (e.g., W2 – W1, W3 – W2, W7 – W6, W8 – W7) in the lower range 111 and the upper range 115. Thus, the population of representative weights is configured to be relatively coarse in the middle range 113; and the population of representative weights is configured to be relatively dense in the lower range 111 and the upper range 115.

For example, the representative weights (e.g., W4 and W5) allocated to the middle range 113 can be evenly distributed in the middle range 113 with an inter-weight gap that is equal to the difference between the two thresholds (which is equal to the size of the middle range 113) divided by the number of representative weights allocated to the middle range 113.

For example, the representative weights (e.g., W1, W2, and W3) allocated to the lower range 111 can be evenly distributed in the lower range 111 with an inter-weight gap that is equal to the size of the lower range 111 divided by the sum of -0.5 and the number of representative weights allocated to the lower range 111.

Similarly, the representative weights (e.g., W6, W7, and W8) allocated to the upper range 115 can be evenly distributed in the upper range 115 with an inter-weight gap that is equal to the size of the upper range 115 divided by the sum of -0.5 and the number of representative weights allocated to the upper range 115.

Optionally, the upper range 115 and the lower range 111 can be configured, via the selection of thresholds 117 and 119 to have a same size. Optionally, the upper range 115 and the lower range 111 can be configured to have a same inter-weight gap.

When the representative weights are distributed according to a pattern as described above, the locations of the representative weights (e.g., W1 to W8) can be determined from one or more parameters, such as the lower threshold 117 and the higher threshold 119. The adjustments of the locations of the representative weights in the weight space can be controlled via the adjustments to the parameters. Optionally, the locations of the representative weights in the weight space can be individually adjusted to maximize the flexibility in optimizing the overall accuracy of the quantized model.

Since the representative weights are not uniformly distributed across the entire range of weights, there is no linear mapping that can be used to map the indexes of the weights to their respective locations in the weight space.

For the given locations of the representative weights, each weight used in the artificial neural network can be replaced by (and thus rounded to) a closest one of the representative weights. The rounding errors are generally higher for the weight ranges having a larger inter-weight gap and lower for the weight ranges having a smaller inter-weight gap.

The representative weights (e.g., W1 to W8) can be represented by the conductance of a memristor in an analog compute module for performance of multiplication and accumulation involving a weight.

FIG. 1 further shows an example of a conductance voltage curve 105. For a given programming voltage used to program the conductance of the memristor, the curve 105 identifies a resulting conductance that the memristor has after the programming operation.

The conductance voltage curve 105 can be used to determine a programming voltage usable to program a memristor to have a conductance to implement a representative weight in multiplication and accumulation computation.

For example, a linear mapping 103 can be used to map the range of representative weights (e.g., W1 to W8) to a range of conductance (e.g., G1 to G8). The order of the linear mapping 103 and a multiplication and accumulation operation can be changed without affecting the result. Thus, the multiplication and accumulation operation involving the weights can be performed by applying the multiplication and accumulation operation to the corresponding conductance and then applying the linear mapping 103 to obtain the result of the multiplication and accumulation operation being applied to the weights.

For example, to implement a representative weight W4 (W2 or W7), the correspond conductance G4 (G2 or G7) as identified by the linear mapping 103 can be used. To program a memristor to have the corresponding conductance G4 (G2 or G7), the corresponding programming voltage V4 (V2 or V7) can be applied.

In general, different regions of programming voltages can have different accuracy levels in achieving the programmed conductance of the memristors. For example, a same amount of variation in the applied programming voltage can cause different amounts of variations in the resulting conductance and thus the weight represented by the conductance. Optimization of the overall accuracy of the quantized model can be performed to account for not only rounding inaccuracy in quantization, but also the inaccuracy in the programming of the conductance of memristors to implement the representative weights.

By adjusting the mapping 103 and the locations of the representative weights in the weight space, the resulting quantized model can have improved and/or optimized accuracy performance.

FIG. 2 illustrates the optimization of a quantized model having a predetermined number of representative weights according to one embodiment.

For example, the optimization of FIG. 2 can be implemented based on the use of the technique of FIG. 1.

In FIG. 2, an artificial neural network model 131 has a large number of different weights 133. The weights 133 can have rates of incidence according to the distribution curve 101 in FIG. 1.

A set of representative weights (e.g., W1 to W8) having a nonlinear distribution 137 (e.g., as in FIG. 1) can be identify so that the weights in the lower range 111 and the upper range 115 have smaller rounding errors than the weights in the middle range 113.

During the operation of quantization 151, each of the weights 133 is substituted by a weight index 134 of its closest representative weight in the list 135 of representative weights (e.g., W1 to W8). Thus, the weights 133 are approximated with the representative weights (e.g., W1 to W8) identified by the weight indexes 134. Quantization 151 reduces the storage size of the quantized model 132, but degrades the accuracy level 139 of the quantized model 132.

The nonlinear distribution 137 of the list 135 of the representative weights (e.g., W1 to W8) can be adjusted to change the model accuracy level 139. Adjustments 141 can be explored to search for a nonlinear distribution 137 that improves the accuracy level 139.

For example, when the locations of the representative weights (e.g., W1 to W8) are controlled by the thresholds 117 and 119, the thresholds 117 and 119 can be adjusted to change the nonlinear distribution 137. A change that leads to improvement in the model accuracy level 139 can be accepted; and a change that leads to degradation in the model accuracy level 139 can be reversed.

The accuracy level 139 of the quantized model 132 can be evaluated by comparing the outputs generated by the quantized model 132 and the outputs generated by the original artificial neural network (ANN) model 131.

For example, the computations of the original artificial neural network (ANN) model 131 responsive to a set of inputs can be performed using a computing system to generate a set of outputs. The computations of the quantized model 132 responsive to a same set of inputs can be performed using the computing system to generate another set of outputs. For example, the computing system can be configured to implement the weights in a digital form (e.g., processed using logic circuits without losing accuracy). Thus, the differences between the sets of outputs are the result of replacing the original weights 133 with the closest representative weights in the list 135. The differences can be measured to generate an indicator of the accuracy level 139. The adjustments can be performed to reduce or minimize the differences.

Optionally, instead of using the same computing system to perform the computations of the quantized model 132, a computing system configured to accelerate multiplication and accumulation operations in an analog form using memristors can be used to generate the outputs of the quantized model 132. For example, the representative weights (e.g., W1 to W8) can be implemented in computations via respective conductance (e.g., G1 to G8) achieved through applying programming voltages (e.g., V1 to V8). Thus, the different between the sets of outputs are the result of replacing the original weights 133 with the closest representative weights in the list 135 implemented through programming voltages applied to memristors. The differences can be measured to generate an indicator of the accuracy level 139. The adjustments can include the changes of the locations of the representative weights in the weight space and the linear mapping 103 to reduce or minimize the differences caused not only by the quantization 151 but also by the programming of memristor conductance.

Optionally, a training dataset is further used to train the quantized model 132 by adjusting the weight indexes 134 and the representative weights (e.g., W1 to W8) in the list 135.

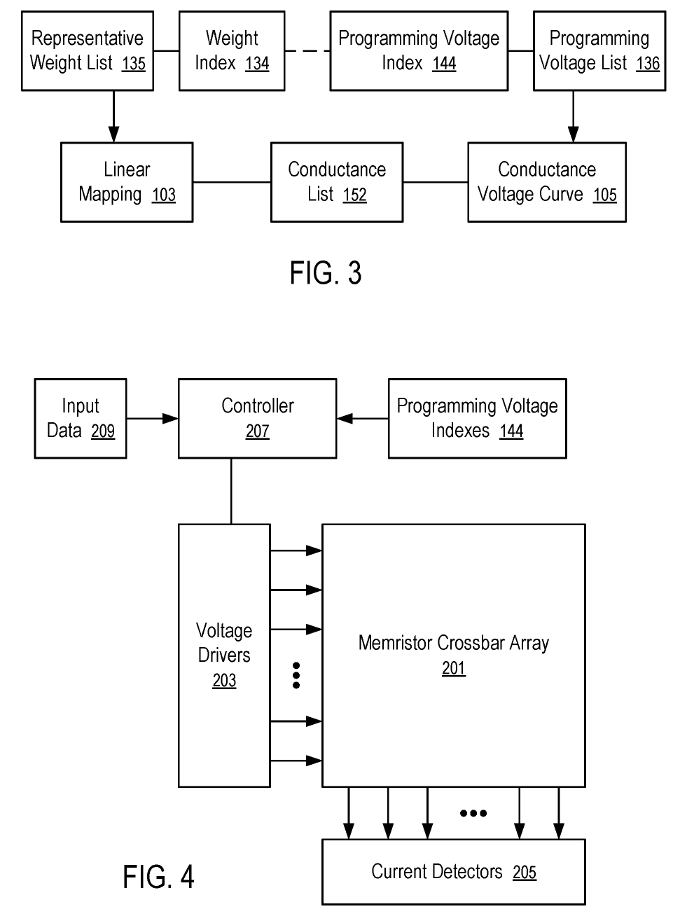

FIG. 3 shows the mapping between representative weights and voltages to program a memristor to have the representative weights of a nonlinear distribution according to one embodiment.

In FIG. 3, a list 135 of representative weights (e.g., W1 to W8) for quantization 151 in FIG. 2 can be mapped to a list 152 of conductance values (e.g., G1 to G8) using a linear mapping 103 (e.g., as illustrated in FIG. 1). Adjusting the linear mapping 103 can map the range of representative weights (e.g., W1 to W8) to different regions of the conductance voltage curve 105. Implementing the same list 135 of representative weights (e.g., W1 to W8) using different regions of the conductance voltage curve 105 can result in different accuracy levels 139 of running the quantized model 132 using an accelerator that is configured to use memristor conductance to implement weights in multiplication and accumulation computations.

In FIG. 3, the list 152 of conductance values (e.g., G1 to G8) can be mapped to a list 136 of programming voltages (e.g., V1 to V8) using a conductance voltage curve 105 (e.g., as illustrated in FIG. 1).

After the determination of the list 136 of programming voltages (e.g., V1 to V8), a weight index 134 (e.g., 2 or 4) identifying a representative weight (e.g., W2 or W4) in the list 135 can be implemented via programming a memristor having the conductance voltage curve 105. For example, the weight index 134 (e.g., 2 or 4) can be used as the corresponding programming voltage index 144 (e.g., 2 or 4) to determine, from the programming voltage list 136, a programming voltage (e.g., V2 or V4). When the memristor is programmed using the programming voltage (e.g., V2 or V4), the memristor has a conductance value (e.g., G2 or G4) that implements the representative weight (e.g., W2 or W4).

In some implementations, the linear mapping 103 is incorporated into the quantized model 132. Thus, the results of multiplication and accumulation applied to conductance values can be used directly in subsequent computations (e.g., evaluation of activation functions).

In some implementations, the linear mapping 103 is used to convert the results of multiplication and accumulation applied to conductance values into multiplication and accumulation applied to representative weights (e.g., W1 to W8), before being used in subsequent computations (e.g., evaluation of activation functions).

FIG. 4 shows the programming of a memristor crossbar array to implement multiplication and accumulation operations of a quantized model according to one embodiment.

For example, the multiplication and accumulation operations as applied to the weights 133 of an artificial neural network (ANN) model 131 can be implemented as multiplication and accumulation operations on representative weights in the list 135 for a respective quantized model 132 of FIG. 2 using a memristor crossbar array 201 of FIG. 4.

In FIG. 4, a controller 207 is configured (e.g., via a logic circuit and/or instructions) to use voltage drivers 203 to apply voltages to the memristor crossbar array 201.

To prepare the memristor crossbar array 201 for multiplication and accumulation operations, the controller 207 uses the voltage drivers 203 to apply programming voltages onto memristors in the crossbar array 201 to change, and thus program, the conductance values of the memristors.

For example, when a memristor in the array 201 is to have a conductance value to implement a representative weight having a weight index 134 in the weight list 135, the controller 207 can use a corresponding programming voltage index 144 to identify a programming voltage in the programming voltage list 136 (e.g., as in FIG. 3). The controller 207 can instruct the voltage drivers 203 to apply the programming voltage to the memristor in the array 201 such that after the programming operation, the conductance of the memristor has a corresponding value in the conductance list 152 corresponding to the representative weight list 135.

After the memristors in the array 201 are programmed to have conductance values representative of the representative weights of a matrix in the quantized model 132, the controller 207 can use the voltage drivers 203 to drive input voltages onto wordlines in the array 201 according to the input data 209 to be applied to the matrix. For example, the input voltages can be proportional to the data elements in the input data 209.

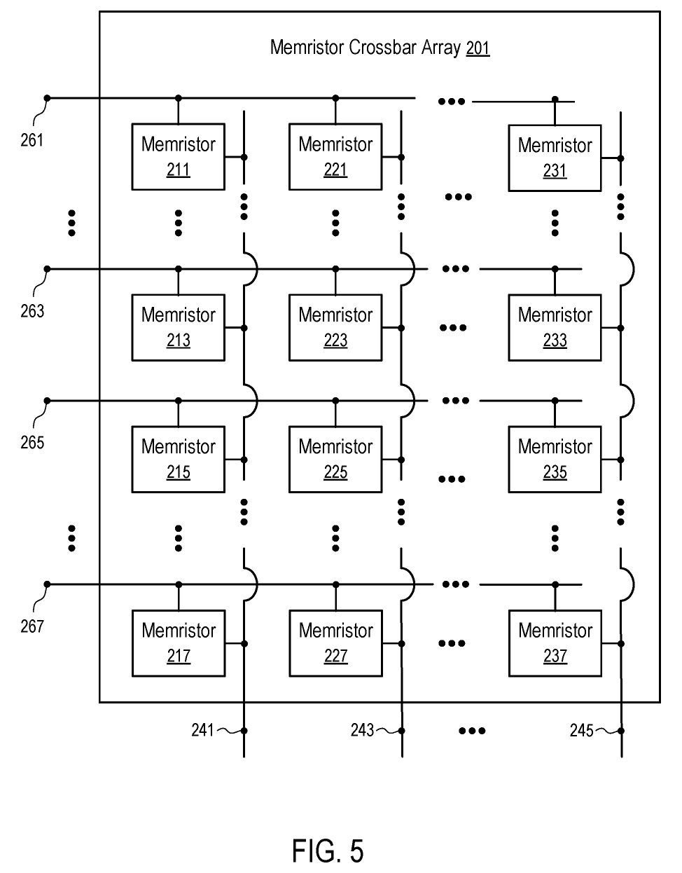

Bitlines in the memristor crossbar array 201 are configured to collect currents going through respective columns of memristors in the array 201. The current detectors 205 are configured to measure the currents collected into the bitlines. The amount of current going through a memristor is equal to the multiplication of the conductance value of the memristor by the input voltage applied to the memristor. The amount of current collected by a bitline is equal to the sum of currents going through a column of the memristors in the array 201. Thus, the current measured by a current detector 205 on a bitline corresponds to the result of multiplication and accumulation of the conductance values by a column of memristors in the array 201 with the input voltages applied according to the input data 209, as further illustrated and discussed in connection with FIG. 5.

FIG. 5 shows a memristor crossbar array of an analog compute module to implement multiplication and accumulation operations of a quantized model according to one embodiment. For example, the memristor crossbar array 201 of FIG. 4 can be implemented in a way as illustrated in FIG. 5.

In FIG. 5, each of the memristors in the crossbar array 201 is connected between a wordline (e.g., 261) and a bitline (e.g., 241). A pair of voltage drivers (e.g., among voltage drivers 203 in FIG. 4) connected to the wordline (e.g., 261) and the bitline (e.g., 241) can be instructed or controlled by a controller (e.g., 207 in FIG. 4) to apply a programming voltage (e.g., V2 or V4 in FIG. 1) to a memristor (e.g., 211) in programming the conductance of the memristor (e.g., 211) to a value (e.g., G2 or G4 in FIG. 1) to implement a respective representative weight (e.g., W2 or W4 in FIG. 1) used in a quantized model (e.g., 132 in FIG. 2).

During the operations of multiplication and accumulation, the wordlines 261, …, 263, 265, …, 267 are configured to receive input voltages (e.g., generated according to input data 209 in FIG. 4); the bitlines 241, 243, …, 245 are configured to provide output currents to current detectors (e.g., 205 in FIG. 4); and the memristor crossbar array 201 can generate output currents on the bitlines 241, 243, …, 245 that have magnitudes corresponding to the results of multiplication and accumulation operations as applied to a matrix of conductance values programmed into the memristor crossbar array 201 and a column of voltage levels applied according to the input data 209.

For example, when an input voltage is applied on the wordline 261, the voltage generates currents flowing to the bitlines 241, 243, …, 245 through a row of memristors 211, 221, …, 231 respectively in the array 201. The contributions from the input voltage as applied on the wordline 261 to the currents in the bitlines 241, 243, …, 245 are proportional to conductance values of the row of memristors 211, 221, …, 231,

The bitlines 241, 243, …, 245 sum the electric currents contributed to the bitlines 241, 243, …, 245 from the input voltages applied on the wordlines 261, …, 263, 265, …, 267. Thus, the currents in the bitlines 241, 243, …, 245 correspond to the summation of the multiplications of the memristor conductance values with the input voltages of the wordlines 261, …, 263, 265, …, 267 that represent the input data 209.

For example, the contributions of the input voltages on the wordlines 261, …, 263, 265, …, 267 to the bitline 241 are summed via the currents flowing from the wordlines 261, …, 263, 265, …, 267 through the memristors 211, …, 213, 215, …, 217 to the bitline 241; the contributions of the voltages on the wordlines 261, …, 263, 265, …, 267 to the bitline 243 are summed via the currents flowing from the wordlines 261, …, 263, 265, …, 267 through the memristors 221, …, 223, 225, …, 227 to the bitline 243; and the contributions of the voltages on the wordlines 261, …, 263, 265, …, 267 to the bitline 245 are summed via the currents flowing from the wordlines 261, …, 263, 265, …, 267 through the memristors 231, …, 233, 235, …, 237 to the bitline 245.

Thus, the memristor crossbar array 201 can be used to perform multiplication and accumulation operations.

For example, the current detectors 205 include analog to digital converter (ADCs) to measure the currents flowing through the bitlines 241, 243, …, 245. The measurement results of the current detectors 205 can be further operated upon (e.g., using a logic circuit) according to the quantized model 132.

In some implementations, the quantized model 132 includes the determination of whether the currents are above one or more thresholds. The current detectors 205 can include comparators to generate digital outputs of whether the currents on the bitlines 241, 243, …, 245 are above thresholds specified for the respective bitlines 241, 243, …, 245.

In one embodiment, a method is provided to implement the computations of an artificial neural network in an analog compute module. For example, the method can be implemented in a computing device having at least one processor (e.g., microprocessor) and a memory sub-system having a memristor crossbar array 201 usable to accelerate operations of multiplication and acceleration (e.g., as in FIGS. 4 and 5). The method can be implemented using the techniques of FIGS. 1, 2 and 3.

For example, the method includes: receiving first data representative of an artificial neural network model 131 having first weights 133; identifying a predetermined number of unique, second weights (e.g., as in the representative weight list 135, such as W1, W2, …, W8 in FIG. 1) having a nonlinear distribution in a weight space of the first weights 133; generating second data representative of a quantized model 132 based on replacing, in the artificial neural network model 131, the first weights 133 with closest ones from the second weights (e.g., in the representative weight list 135); identifying a linear mapping 103 between the second weights (e.g., W1 to W8 in FIG. 1) and values of conductance of memristors of an accelerator configured to perform operations of multiplication and accumulation; determining, based on the linear mapping 103, the predetermined number of programming voltages (e.g., as in the programming voltage list 136, such as V1, V2, …, V8 in FIG. 1); and programming conductance of the memristors (e.g., in memristors crossbar array 201) using the programming voltages (e.g., V1, V2, …, V8) in preparation of the accelerator (e.g., memristors crossbar array 201) to perform an operation of multiplication and accumulation in the quantized model 132.

For example, the method can further include: adjusting the nonlinear distribution and/or the linear mapping to improve an accuracy level of the quantized model 132 resulting from replacing the first weights 133 with closest ones from the second weights (e.g., in the weight list 135).

For example, the method can further include: dividing the weight space into: a lower range 111 having weights smaller than a first threshold 117; an upper range 115 having weights larger than a second threshold 119 larger than the first threshold 117; and a middle range 113 having weights between the first threshold 117 and the second threshold 119. The predetermined number of the second weights (e.g., in the list 135) can be allocated to the lower range, the middle range, and the upper range to control the allocation of rounding error precision during quantization 151.

For example, a gap between two adjacent ones of the second weights in the middle range 113 can be configured to be larger than any gap between two adjacent ones of the second weights in the lower range 111 and any gap between two adjacent ones of the second weights in the upper range 115. Thus, the rounding errors can be distributed more to the middle range 113 and to the upper range 115 and the lower range 111, since the weights in the upper range 115 and the lower range 111 can be more important to the artificial neural network model 131 than the weights in the middle range 113.

Optionally, within each of the middle range 113, the lower range 111, and the upper range 115, the second weights can be configured to be uniformly spaced for simplification, even though the second weights across the ranges 111, 113 and 115 are non-uniform and not evenly space. For example, the adjusting of the nonlinear distribution can be performed via adjusting the first threshold 117, or the second threshold 119, or both. Alternatively, the second weights can be non-uniformly distributed even within each of the middle range 113, the lower range 111, and the upper range 115.

For example, the method can further include: comparing first outputs of the quantized model 132 and second outputs of the artificial neural network model 131, responsive to a same set of inputs, to evaluate an accuracy level 139 of the quantized model 132. The distribution of locations of the representative weights (e.g., W1 to W8) in the weight space can be adjusted to improve or optimize the accuracy level 139. Optionally, the linear mapping 103 is also adjusted to improve or optimize the accuracy level 139.

For example, the method can further include: generating the first outputs of the quantized model 132 using a same computing device used to generate the second outputs of the artificial neural network model 131. The computation device can have an accuracy level in weight implementations that matches with the first weights 133 of the artificial neural network model 131.

Alternatively, different computing devices can be used to generate the first outputs of the quantized model 132 and the second outputs of the artificial neural network model 131. For example, the method can further include: generating the first outputs of the quantized model 132 using the accelerator (e.g., memristor crossbar array 201) having memristors programmed to have conductance using the programming voltages (e.g., in the list 136); and generating the second outputs of the artificial neural network model 131 without using the accelerator. Thus, the first outputs can be computed to include the rounding errors of the quantization 151 and the errors of the memristor conductance implementation of the second weights; and the second outputs can be computed to exclude the errors in implementing the first weights 133, such as the rounding errors of the quantization 151.

Optionally, the method can further include: training, using a training dataset of the artificial neural network model 131, the quantized model 132 having weights limited to be selected from the second weights (e.g., as in the weight list 135).

Fabrication process variation (FPV) can cause memristors, configured to implement the weights 133 of the artificial neural network model 131, to have different conductance values when programmed using a same programming voltage. For example, different memristors (e.g., 211, 221, 237) in a memristor crossbar array 201 can have different conductance voltage curves due to fabrication process variation (FPV).

To implement the weights from the representative weight list 135 with precision, the conductance voltage curves (e.g., 105) of the individual memristors can be measured to determine the programming voltage lists (e.g., 136) of different memristors (e.g., 211, 221, 237) in implementing the weights, selected from the same representative weight list 135, using the conductance of the memristors (e.g., 211, 221, 237).

However, measuring the conductance voltage curves (e.g., 105) of individual memristors (e.g., 211, 221, 237) and programming weights according to the different conductance voltage curves (e.g., 105) can be time consuming and inefficient.

In at least some embodiments, the fabrication process variations in the memristors are processed as random noises; and the quantized model 132 is optimized to reduce the effect of the random noises. The optimization of the quantized model (e.g., as in FIG. 2) can be configured to reduce or minimize not only the rounding errors introduced in the quantization 151, but also the random noises resulting from fabrication process variations in the memristors used to implement the representative weights.

In general, different memristors (e.g., 211, 221, 237) can have different conductance voltage curves (e.g., 105); and in some implementations, the conductance voltage curve (e.g., 105) of a memristor (e.g., 211) can change after a period of time. Thus, it can be impractical to customize the controls applied to program the individual memristors to have conductance values representative of weights.

Instead, a same set of voltages can be used to program the conductance values of memristors having fabrication process variations; and the voltages can be optimized for a set of memristors (e.g., in a memristor crossbar array 201, an accelerator of multiplication and accumulation, a memory sub-system containing memristors configured to accelerate operations of multiplication and accumulation) to reduce or minimize the effect of the random noises resulting from the same set of programming voltages for memristors having fabrication process variations.

For example, a nominal conductance voltage curve (e.g., 105) can be measured for a set of memristors and used to determine the programming voltages in implementing the representative weights via the conductance of the memristors.

When memristors having different conductance voltage curves are programmed to implement the representative weights using the same nominal conductance voltage curve (e.g., 105), the programmed conductance values of the memristors can deviate from the conductance values predicted via the nominal conductance voltage curve (e.g., 105). The deviation can be processed as random noises in the weights implemented using the conductance of the memristors. The effect of the random noises can be reduced or minimized as part of the rounding errors introduced in the quantization 151, where the original weights 133 of the artificial neural network model 131 are replaced and thus approximated using the weights that are programmed using the voltages selected from in the programming voltage list 136 determined using the nominal conductance voltage curve (e.g., 105).

Thus, both the effect of the random noises, resulting from the fabrication process variations in the memristors, and the effect of the rounding errors for the use of the representative weight list 135 can be formulated as the effect of rounding the original weights 133 towards weights programmed into memristors according to the same programming voltage list 136. The effect of rounding can be reduced in the minimization of the differences between the accurate outputs of the artificial neural network model 131 having the original weights 133 and the approximated outputs of the quantized model 132 implemented using the memristors having the fabrication process variations.

For example, the accurate outputs of the artificial neural network model 131 having the original weights 133 can be computed using a computing device that does not introduce the round errors and/or the random noises corresponding to the fabrication process variations in memristors. For example, such a computing device can perform the computations involving the original weights 133 using a logic circuit, a microprocessor, a graphical processing unit, etc. without decreasing the precision of the original weights 133. The approximated outputs of the quantized model 132 can be generated using memristors having the nominal conductance voltage curve (e.g., 105) to implement the operations of multiplication and accumulation.

The nominal conductance voltage curve (e.g., 105) of a set of memristors can be measured without measuring the conductance voltage curves of individual memristors in the set.

For example, memristors in the memristor crossbar array 201 can be applied a same programming voltage. Instead of measuring the conductance values of individual memristors in the array 201 to obtain a nominal conductance value (e.g., as an average or median of the conductance values of the memristors) resulting from programming using the same programming voltage, the conductance value of the entire array 201 can be measured to determine a nominal conductance value for each of the memristors in the array. For example, based on an assumption that the conductance values of individual memristors in the array 201 are the same, the nominal conductance value for a typical memristor in the array can be calculated from the conductance value of the entire array 201.

For example, the voltage drivers 203 can be used to apply a same input voltage to the wordlines 261, …, 263, 265, …, 267 to determine a sum of the currents in the bitlines 241, 243, …, 245. The conductance value of the entire array 201 can be determined from the ratio between the sum of the currents and the input voltage; and the nominal conductance value of a typical memristor programmed via the same programming voltage can be determined as the conductance value of the array 201 divided by the count of the memristors 211, …, 237 in the array 201.

Optionally, a nominal conductance voltage curve can be measured for a section of the array 201, for a column of the array 201, and/or for a row of the array 201. Nominal conductance voltage curves of different portions of the array 201 (e.g., sections, columns, rows) can be compared to determine whether to program a portion of the array 201 according to a separate nominal conductance voltage curve.

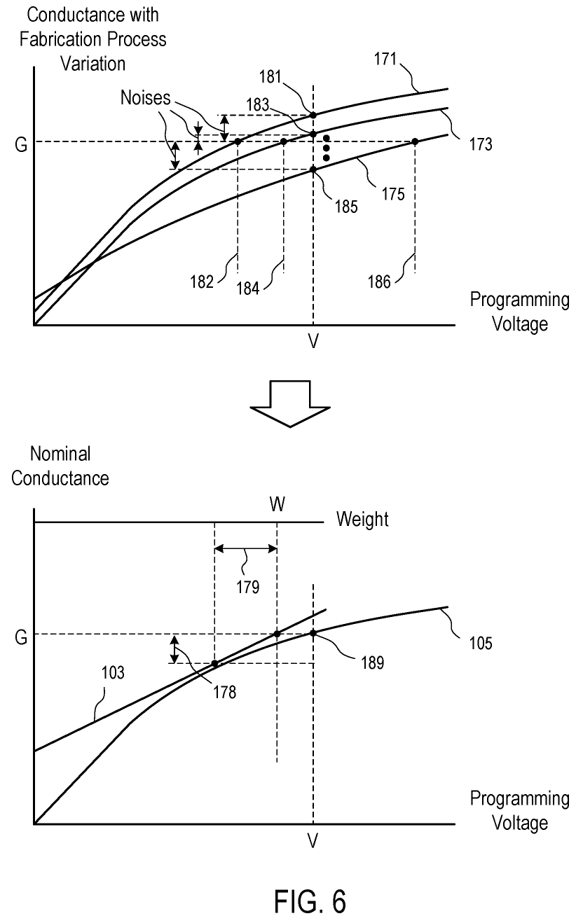

FIG. 6 shows a technique to account for fabrication process variations in memristors using a nominal conductance voltage curve in quantization of weights according to one embodiment.

As illustrated in FIG. 6, different memristors (e.g., 211, 221, …, 237 in array 201 of FIG. 5) can have different conductance voltage curves 171, 173, …, 175 due to fabrication process variations.

For example, the memristors (e.g., 211, 221, …, 237 in array 201 of FIG. 5) can have different conductance values 181, 183, …, 185 when programmed via a same programming voltage V.

To accurately program the memristors (e.g., 211, 221, …, 237 in array 201 of FIG. 5) to a conductance value (e.g., G6) to implement a representative weight (e.g., W6), the different conductance voltage curves 171, 173, …, 175 require the use of different programming voltages 182, 184, …, 186.

It can be time consuming to separately measure the conductance voltage curves 171, 173, …., 175, and to program the memristors (e.g., 211, 221, …, 237 in array 201 of FIG. 5) according to the different conductance voltage curves 171, 173, …., 175.

In FIG. 6, a nominal conductance programming curve 105 can be used to determine that the programming voltage V at a point 189 on the curve 105 can be used to program a nominal conductance value G for implementing a weight W (e.g., a representative weight G6 in FIG. 1).

Since programming the memristors (e.g., 211, 221, …, 237 in array 201 of FIG. 5) using the programming voltage V actually results in the memristors (e.g., 211, 221, …, 237 in array 201 of FIG. 5) having different programmed conductance values 181, 183, …, 185, the deviations of the programmed conductance values 181, 183, …, 185 from the nominal conductance value G are the noise errors resulting from programming the memristors (e.g., 211, 221, …, 237 in array 201 of FIG. 5) using the same programming voltage V determined from the nominal conductance voltage curve.

The linear mapping 103 (e.g., as in FIG. 1) between the nominal conductance values (e.g., G) and the weights (e.g., W) implemented via the conductance values (e.g., G) can map the deviations (e.g., 178) of the programmed conductance values (e.g., 181, 183, …, 185) from the nominal conductance value G as the noise errors (e.g., 179) in the weights (e.g., W) implemented by the memristors (e.g., 211, 221, …, 237 in array 201 of FIG. 5) programmed using the same programming voltage V.

In general, when the original weights 133 of the artificial neural network model 131 are quantized via a same programming voltage list 136 determined using the nominal conductance voltage curve 105, instead of the individual conductance voltage curves of the memristors, the noise errors (e.g., 179) can have random effects. In some instances, the noise errors (e.g., 179) can reduce, or cancel a portion of, the rounding errors of implementing the original weight 133 using a representative weight W selected to replace the original weight 133. In other instances, the noise errors (e.g., 179) can add to, or enlarge, the rounding errors.

The evaluation of the model accuracy level 139 (e.g., as in FIG. 2) can be configured to include the effects of the noise errors (e.g., 179). Thus, the adjustments 141 (e.g., as in FIG. 2) can be made to increase the model accuracy level 139 and reduce the effect of the noise errors (e.g., 179) and the rounding errors.

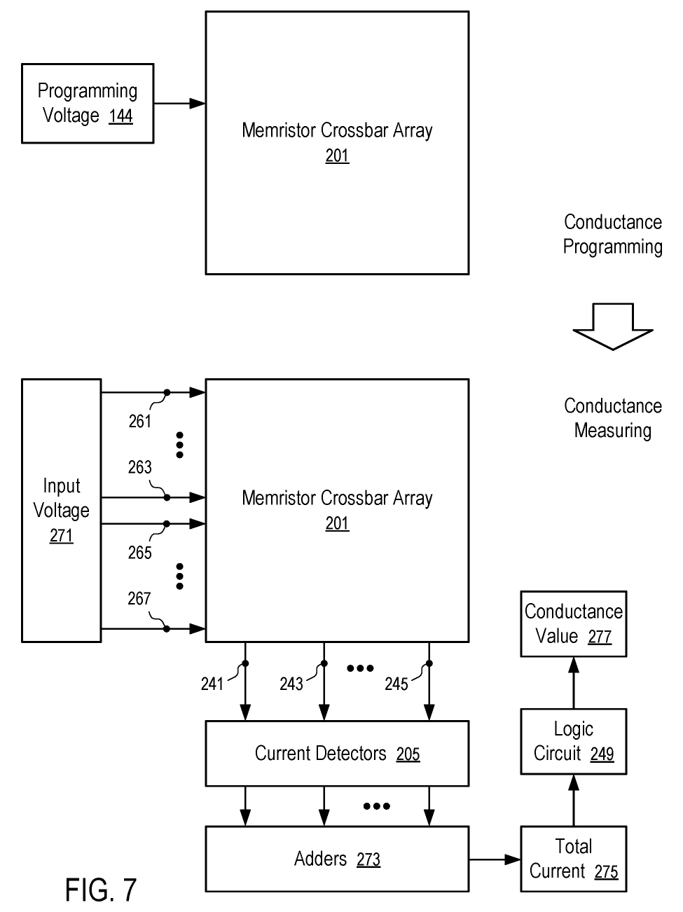

FIG. 7 shows measuring a nominal conductance voltage curve of a memristor crossbar array according to one embodiment.

For example, the nominal conductance voltage curve 105 in FIG. 6 can be measured in a way as illustrated in FIG. 7 without the need to measure the conductance voltage curves 171, 173, …, 175 of individual memristors (e.g., 211, 221, …, 237 in array 201 of FIG. 5).

In FIG. 7, a same programming voltage 144 is used to program the memristors in the array 201. As illustrated in FIG. 6, the memristors (e.g., 211, 221, …, 237) in the array 201 can have different conductance values due to fabrication process variations, even though the same programming voltage 144 is used to program the conductance of the memristors (e.g., 211, 221, …, 237).

Instead of measuring the programmed conductance values of the individual memristors (e.g., 211, 221, …, 237) in the array 201, a nominal conductance value of the memristors (e.g., 211, 221, …, 237) programmed using the voltage 144 can be measured by applying a same input voltage 271 to the wordlines 261, …, 263, 265, …, 267 of the memristor crossbar array 201. The current detectors 205 can be used to measure the magnitudes of currents in the bitlines 241, 243, …, 245 of the memristor crossbar array 201. A set of adders 273 can be used to sum the results from the current detectors 205 to determine the total current 275 produced by the memristor crossbar array in response to the input voltage 271. A logic circuit 249 can be used to determine the nominal conductance value 277 of each memristor in the array 201 from the total current 275.

For example, dividing the magnitude of the total current 275 by the magnitude of the input voltage 271 and a count of memristors in the array 201 can provide an average of conductance values of the memristors in the array 201. The average can be used as the nominal conductance value 277 of a typical memristor in the array 201 programmed using the programming voltage 144.

The operations of FIG. 7 can be repeated for a plurality of programming voltage (e.g., 144) to obtain a nominal conductance voltage curve 105.

Optionally, the nominal conductance value programmed via the voltage 144 can be measured for a portion of the array, such as one or more columns of the array 201 and one or more rows of the array 201.

For example, instead of applying the input voltage 271 to all of the wordlines 261, …, 263, 265, …, 267, the voltage drivers 203 can be used to apply the input voltage 271 to one or more selected wordlines and zero voltages to the remaining wordlines. Thus, the conductance values of memristors connected to the one or more selected wordlines have contributions to the currents in the bitlines 241, 243, …, 245 measured by the current detectors 205, while the other memristors are not used in producing the currents in the bitlines 241, 243, …, 245. Thus, the total current 275 in the bitlines 241, 243, …, 245 represents an average of the conductance values of one or more rows of memristors connected to the selected wordlines.

For example, instead of summing the currents from all of the bitlines 241, 243, …, 245, the adders 273 can be configured to sum the currents in one or more of the bitlines 241, 243, …, 245 to measure the nominal/average conductance values of one or more columns of memristors connected the selected bitlines.

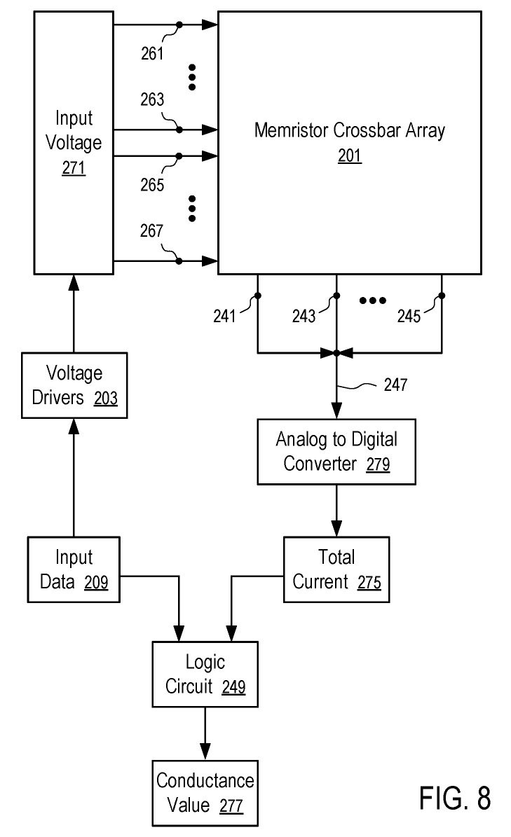

Optionally, the summing of the currents in the bitlines 241, 243, …, 245 can be performed in an analog form, as illustrated in FIG. 8.

FIG. 8 shows another method of measuring a nominal conductance voltage curve of a memristor crossbar array according to one embodiment.

In FIG. 8, the memristors in the array 201 can be programmed using a same voltage 144 as in FIG. 7.

To measure the nominal/average conductance value of the memristors programmed using the voltage 144, input data 209 can be used to instruct the voltage drivers 203 to apply the input voltage 271 to the wordlines 261, …, 263, 265, …, 267. The output currents from the bitlines 241, 243, …, 245 can be collected into a line 247 for measuring using an analog to digital converter 279. For example, the analog to digital converter 279 can be configured to have a high precision than the current detectors 205 configured to perform multiplication and accumulation operations.

A logic circuit 249 can receive the input data 209 and the total current 275 output from the analog to digital converter 279 to compute a nominal/average conductance value of the memristors in the array 201.

As in FIG. 7, the input data 209 can be selected to measure the nominal/average conductance value of selected rows of memristors that are connected to some of the wordlines 261, …, 263, 265, …, 267. Similarly, collecting of the currents from the bitlines 241, 243, …, 245 into the line 247 for measuring by the analog to digital converter 279 can be configured to be selected to include some bitlines but not the others to measure the nominal/average conductance value of selected columns of memristors that are connected to the selected bitlines.

A section of the array 201 can be selected for measuring by selecting a subset of the wordlines 261, …, 263, 265, …, 267 and a subset of the bitlines 241, 243, …, 245.

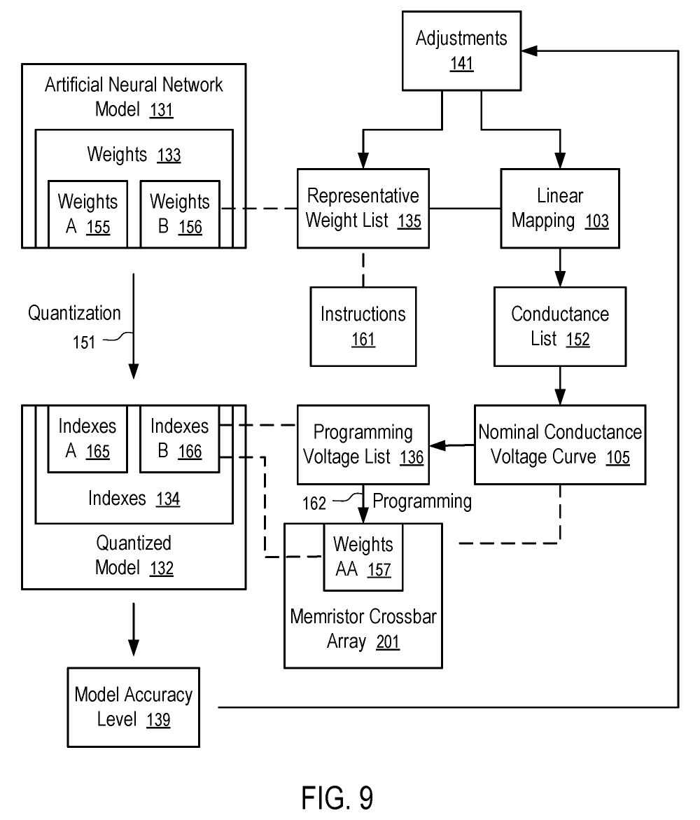

FIG. 9 shows the optimization of a quantized model to account for fabrication process variations according to one embodiment.

In FIG. 9, quantization 151 of the artificial neural network model 131 is performed for acceleration of multiplication and accumulation operations using a memristor crossbar array 201 having a nominal conductance voltage curve 105.

For example, the nominal conductance voltage curve 105 of the memristor crossbar array 201 can be measured using the techniques of FIGS. 7 or 8.

Based on a set of instructions 161 to run the artificial neural network model 131, the weights 156 of the artificial neural network model 131 to be implemented via programmed conductance values of memristors in the array 201 can be identified.

In some implementations, a portion (e.g., weights 156) of the original weights 133 of the artificial neural network model 131 is implemented in the memristor crossbar array 201; and the remaining portion (e.g., weights 155) is implemented using another device, such as another memristor crossbar array 201, a microprocessor, a graphic processing unit, a logic circuit based accelerator of multiplication and accumulation operations, or another type of multiplication and accumulation accelerator.

Optionally, the instructions 161 can be configured to implement the entire set of original weights 133 using the memristor crossbar array 201, or multiple the memristor crossbar arrays (e.g., 201) having the same or similar nominal conductance voltage curve 105.

In FIG. 9, the weights 156 to be implemented via one or more memristor crossbar arrays (e.g., 201) having the nominal conductance voltage curve 105 are quantized 151 to be represented by respective indexes 166 identifying the programming voltages in a list 136 determined using the nominal conductance voltage curve 105.

For example, the weights 156 can be rounded up to a predetermined number of representative weights in a list 135 having a nonlinear distribution 137, as in FIGS. 1 and 2.

Through a linear mapping 103, the representative weights in the list 135 can be mapped to a corresponding conductance list 152.

Using the nominal conductance voltage curve 105, a list 136 of programming voltages can be determined to implement the representative weight list 135 using memristors in the array 201.

Thus, each weight 156 can be replaced with an index 166 that identifies a programming voltage in the list 136. The programming voltage identified by the index 166 can be used to program a respective memristor in the array 201 to have a conductance value to implement a corresponding original weight 156 that is closest to a corresponding representative weight in the list 135.

In general, since the memristors in the array 201 have fabrication process variations, the programmed conductance value of the respective memristor in the array 201 deviates from the conductance value in the list 152 corresponding to the index 166. Thus, the weight 157 represented by the programmed conductance value of the respective memristor and mapped via the linear mapping 103 can deviate from the corresponding representative weight in the list 135 corresponding to the index 166. Thus, the weight 156 is quantized and programmed as the weight 157. The difference between the weight 156 and the weight 157 is the net rounding error resulting from implementing the weight 156 using the memristor in the array 201 programmed using the programming voltage identified by the index 166 in the list 136. The net rounding error is the combination of the rounding error in approximating the weight 156 by a closest representative weight in the list 135, and the random noise result from implementing the closest representative weight through programming a memristor, having unknown fabrication process variations, using a programming voltage from the list 136.

When the weights 155 are implemented using another memristor crossbar array having a different nominal conductance voltage curve, the weights 155 can be replaced with respective indexes 165 identifying the programming voltages in a list configured according to the different nominal conductance voltage curve.

When the weights 155 are also implemented via programming the conductance of memristors in the array 201, or another array having the same or similar nominal conductance voltage curve 105, the indexes 165 can be identified based on the programming voltage list 136 in a way similar to the identification of the indexes 166.

The accuracy level 139 of the quantized model 132 can be evaluated via running the quantized model 132 using the memristor crossbar array 201.

For example, for a given set of inputs, the accurate outputs of the artificial neural network model 131 can be computed using a computing device that does not round up the original weights 133. For the same set of inputs, the approximated outputs of the quantized model 132 can be computed using the memristor crossbar array 201 to perform the multiplication and accumulation operations involving the weights 133 that are rounded towards weights 157 implemented via programming the memristors in the array 201 using the programming voltages identified via the indexes 166 from the programming voltage list 136.

Thus, the differences between the accurate outputs and the approximated outputs reflect the net rounding errors in the quantization 151 and conductance programming 162.

Adjustments 141 can be made to the selection of the representative weight list 135 and/or the linear mapping 103. The adjustments can be made incrementally and selected to increase the accuracy level 139 by reducing or minimizing a measure of the differences between the accurate outputs and the approximated outputs.

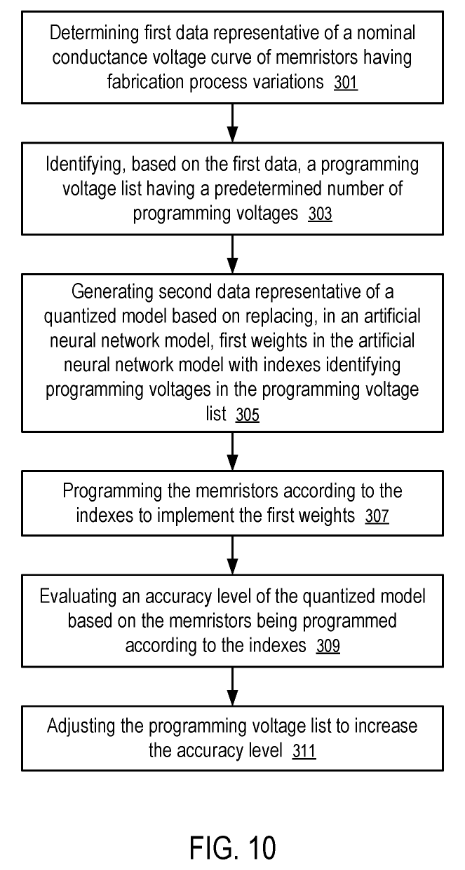

FIG. 10 shows a method of quantization of an artificial neural network model for implementation in an analog compute module having fabrication process variations according to one embodiment.

For example, the method of FIG. 10 can be implemented in a computing device having at least one processor (e.g., microprocessor) and a memory sub-system having a memristor crossbar array 201 usable to accelerate operations of multiplication and acceleration (e.g., as in FIGS. 4 and 5). The method can be implemented using the techniques of FIGS. 1, 2, 3, and 9, and a nominal conductance voltage curve 105 illustrated in FIG. 6 for memristors having fabrication process variations. For example, the nominal conductance voltage curve 105 can be measured according to FIGS. 7 or 8.

For example, the computing device can be a system including a memristor crossbar array 201 and at least one processor (e.g., a microprocessor, a logic circuit 249). The memristor crossbar array 201 can be configured to perform multiplication and accumulation operations based on weights represented by conductance values of memristors 211, …, 237 in the memristor crossbar array 201, where the memristors 211, …, 237 have fabrication process variations that introduce random noises in the multiplication and accumulation operations.

The at least one processor can be configured to: identify, based on first data representative of a nominal conductance voltage curve 105 of the memristors 211, …, 237, a first list 136 having a predetermined number of programming voltages (e.g., V1, V2, …, V8); generate second data representative of a quantized model 132 based on replacing, in an artificial neural network model 131, first weights 156 in the artificial neural network model 131 with indexes 166 identifying programming voltages selected from the first list 136 to implement the first weights 156; program the memristors 211, …, 237 according to the indexes 166 to implement the first weights 156; generate first outputs of the quantized model 132 based on the memristor crossbar array 201 performing multiplication and accumulation operations on the first weights 156 represented by conductance values of the memristors 211, …, 237 programmed according to the indexes 166; and compare the first outputs with second outputs of the artificial neural network model 131 to evaluate an accuracy level 139 of the quantized model 132.

For example, the at least one processor can be further configured to adjust the first list 136 to reduce or minimize differences between the first outputs and the second outputs in the optimization of the quantization 151 of the artificial neural network model 131 to generate the quantized model 132 for execution in the system.

For example, the at least one processor can be further configured to: identify a second list 135 having representative weights (e.g., W1, W2, …, W8) of the predetermined number; and map, based on a linear mapping 103, the representative weights (e.g., W1, W2, …, W8) in the second list 135 to a third list 152 of nominal conductance values (e.g., G1, G2, …, G8) of the predetermined number. The programming voltages (e.g., V1, V2, …, V8) in the first list 136 can be determined according to the nominal conductance voltage curve 105 from the nominal conductance values (e.g., G1, G2, …, G8) in the third list 152.

For example, the at least one processor can be further configured to: replace the first weights 156 with the indexes 166 based on rounding up each of the first weights 156 to a closest representative weight in the second list 135.

For example, the second outputs can be pre-calculated (e.g., using a high precision computing device) to provide a calibration target for the quantization 151 of the artificial neural network model 131 and for running the quantized model 132 in the system.

Optionally, the system can include a logical circuit configured to perform multiplication and accumulation operations on the first weights without quantization. The second outputs can be generated using the logical circuit for the optimization of the quantized model 132.

Optionally, the system can include a circuitry configured to measure the nominal conductance voltage curve 105 of the memristors 211, …, 237.

At block 301, the method includes determining first data representative of a nominal conductance voltage curve 105 of memristors (e.g., 211, …, 237) having fabrication process variations.

For example, fabrication process variations can cause individual memristors (e.g., 211, 221, …, 237) in a crossbar array 201 to have different conductance voltage curves (e.g., 171, 173, …, 175).

At block 303, the method includes identifying, based on the first data representative of the nominal conductance voltage curve 105, a programming voltage list 136 having a predetermined number of programming voltages (e.g., V1, V2, …, V8).

For example, the identifying of the programming voltage list 136 can include: identifying a representative weight list 135 having representative weights (e.g., W1, W2, …, W6) of the predetermined number; mapping, based on a linear mapping 103, the representative weight list 135 to nominal conductance values (e.g., G1, G2, …, G8); and determining, using the first data representative of the nominal conductance voltage curve 105, the programming voltage list 136 from the nominal conductance values (e.g., G1, G2, …, G8).

At block 305, the method includes generating second data representative of a quantized model 132 based on replacing, in an artificial neural network model 131, first weights (e.g., 133 or 156) in the artificial neural network model 131 with indexes (e.g., 134 or 166) identifying programming voltages (e.g., V1, V2, …, V8) in the programming voltage list 136.

For example, the replacing of the first weights (e.g., 133 or 156) with the indexes (e.g., 134 or 166) can include: identifying, for each respective weight in the first weights (e.g., 133 or 156), a closest representative weight in the representative weight list 135; and determining the corresponding index of a programming voltage in the programming voltage list 136 that can produce, according to the nominal conductance voltage curve 105, a conductance value that is mapped by the linear mapping 103 to the closest representative weight (closest, among weights in the representative weight list 135, to the respective weight).

At block 307, the method includes programming 162 the memristors (e.g., 211, 221, …, 237) according to the indexes (e.g., 134 or 166) to implement the first weights (e.g., 133 or 156).

At block 309, the method includes evaluating an accuracy level 139 of the quantized model 132 based on the memristors (e.g., 211, 221, …, 237) being programmed according to the indexes (e.g., 134 or 166).

At block 311, the method includes adjusting the programming voltage list 136 to increase the accuracy level 139.

For example, the adjusting of the programming voltage list 136 includes changing the representative weight list 135, which is mapped by the linear mapping 103 to a changed nominal conductance value list, and then mapped by the nominal conductance voltage curve 105 to the changed programming voltage list 136.

For example, the changing of the representative weight list 135 can include changing a distribution 137 of the representative weights (e.g., W1, W2, …, W8) in a weight space (e.g., in a weight range determined for the first weights (e.g., 133 or 156)).

For example, the positions of the representative weights (e.g., W1, W2, …, W8) in the weight space can be parameterized based on one or more parameters. Changing the parameters can change the positions of the representative weights (e.g., W1, W2, …, W8) systematically. The parameters can be adjusted to search for a programming voltage list 136 that increases and/or maximizes the accuracy level 139 of the quantized model 132 generated according to the programming voltage list 136.

For example, the changing of the representative weight list 135 can include changing spacing of adjacent representative weights in a weight space.

For example, the adjusting of the programming voltage list 136 can include adjusting the linear mapping 103.

For example, the evaluating of the accuracy level 139 of the quantized model 132 can include: computing, using the memristors (e.g., 211, 221, …, 237) programmed according to the indexes (e.g., 134 or 166), first outputs of the quantized model 132 responding to a set of inputs; computing second outputs of the artificial neural network model 131 responding to the same set of inputs; and comparing the first outputs and the second outputs.

For example, a measurement of the differences between the first outputs and the second outputs can be used as an indicator of the accuracy level 139. Reducing the measurement (and the differences) corresponds to increasing the accuracy level 139.

For example, the second outputs can be computed based on implementing the first weights using a logic circuit to avoid or minimize rounding errors introduced in the quantization 151, and random noises caused by fabrication process variation.

Optionally, a device can be configured to measure the nominal conductance voltage curve 105 as in FIGS. 7 or 8. The device can include a memory sub-system having a memristor crossbar array 201, voltage drivers 203 coupled to the memristor crossbar array 201; and a circuitry (e.g., including adders 273, current detectors 205, and/or an analog to digital converters 279) configured to determine a total current 275 in a plurality of bitlines 241, 243, …, 245 of the memristor crossbar array 201. The device can further include a logic circuit 249 configured to: instruct the voltage drivers 203 to apply a same programming voltage 144 to program conductance of memristors (e.g., 211, 221, …, 237) in the memristor crossbar array 201 having fabrication process variations; apply, after programming the memristors (e.g., 211, 221, …, 237) using the programming voltage 144, an input voltage 271 to a plurality of wordlines 261, …, 267 of the memristor crossbar array 201; and determine a nominal conductance value 277 of each memristor in the memristor crossbar array 201 based on the total current 275 determined by the circuitry when the input voltage 271 is applied to the plurality of wordlines 261, …, 267.

For example, the nominal conductance value 277 can be the average of the different conductance values of memristors (e.g., 211, 221, …, 237) that have fabrication process variations and that have been programmed using the same programming voltage 144.

For example, the circuitry can include a plurality of current detectors 205 configured to separately measure currents in the plurality of bitlines 241, 243, …, 245 respectively, as in FIG. 7. The circuitry can further include a plurality of adders 273 configured to sum the outputs of the current detectors 205.

For example, the circuitry can include a circuit configured to collect currents from the plurality of bitlines 241, 243, …, 245 into a common line 247, as in FIG. 8. The circuitry can further include an analog digital converter 279 configured to measure a magnitude of current in the common line 247 as the total current 275.

For example, the logic circuit 249 can be configured to determine the nominal conductance value 277 from dividing the total current 275 by a count of memristors (e.g., 211, 221, …, 237) connected to the plurality of wordlines 261, …, 267 and the plurality of bitlines 241, …, 245.

Optionally, the device includes a plurality of current detectors 205 configured to measure currents in the plurality of bitlines 241, 243, …, 245 respectively during an operation of multiplication and accumulation involving weights implemented via the conductance values of the memristors (e.g., 211, 221, …, 237) in the array 201.

In general, a memory sub-system can be configured as a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The memory sub-system can be installed in a computing system to accelerate multiplication and accumulation applied to data stored in the memory sub-system. Such a computing system can be a computing device such as a desktop computer, a laptop computer, a network server, a mobile device, a portion of a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

In general, a computing system can include a host system that is coupled to one or more memory sub-systems. In one example, a host system is coupled to one memory sub-system. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system can include a processor chipset (e.g., processing device) and a software stack executed by the processor chipset. The processor chipset can include one or more cores, one or more caches, a memory controller (e.g., NVDIMM controller), and a storage protocol controller (e.g., PCIe controller, SATA controller). The host system uses the memory sub-system, for example, to write data to the memory sub-system and read data from the memory sub-system.

The host system can be coupled to the memory sub-system via a physical host interface. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface can be used to transmit data between the host system and the memory sub-system. The host system can further utilize an NVM express (NVMe) interface to access components (e.g., memory devices) when the memory sub-system is coupled with the host system by the PCIe interface. The physical host interface can provide an interface for passing control, address, data, and other signals between the memory sub-system and the host system. In general, the host system can access multiple memory sub-systems via a same communication connection, multiple separate communication connections, or a combination of communication connections.

The processing device of the host system can be, for example, a microprocessor, a central processing unit (CPU), a processing core of a processor, an execution unit, etc. In some instances, the controller can be referred to as a memory controller, a memory management unit, or an initiator. In one example, the controller controls the communications over a bus coupled between the host system and the memory sub-system. In general, the controller can send commands or requests to the memory sub-system for desired access to memory devices. The controller can further include interface circuitry to communicate with the memory sub-system. The interface circuitry can convert responses received from the memory sub-system into information for the host system.

The controller of the host system can communicate with the controller of the memory sub-system to perform operations such as reading data, writing data, or erasing data at the memory devices, and other such operations. In some instances, the controller is integrated within the same package of the processing device. In other instances, the controller is separate from the package of the processing device. The controller or the processing device can include hardware such as one or more integrated circuits (ICs), discrete components, a buffer memory, or a cache memory, or a combination thereof. The controller or the processing device can be a microcontroller, special-purpose logic circuitry (e.g., a field programmable gate array (FPGA), an application specific integrated circuit (ASIC), etc.), or another suitable processor.

The memory devices can include any combination of the different types of non-volatile memory components and volatile memory components. The volatile memory devices can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, or a PLC portion of memory cells, or any combination thereof. The memory cells of the memory devices can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller (or controller for simplicity) can communicate with the memory devices to perform operations such as reading data, writing data, or erasing data at the memory devices and other such operations (e.g., in response to commands scheduled on a command bus by controller). The controller can include hardware such as one or more integrated circuits (ICs), discrete components, or a buffer memory, or a combination thereof. The hardware can include digital circuitry with dedicated (i.e., hard-coded) logic to perform the operations described herein. The controller can be a microcontroller, special-purpose logic circuitry (e.g., a field programmable gate array (FPGA), an application specific integrated circuit (ASIC), etc.), or another suitable processor.

The controller can include a processing device (processor) configured to execute instructions stored in a local memory. In the illustrated example, the local memory of the controller includes an embedded memory configured to store instructions for performing various processes, operations, logic flows, and routines that control operation of the memory sub-system, including handling communications between the memory sub-system and the host system.

In some embodiments, the local memory can include memory registers storing memory pointers, fetched data, etc. The local memory can also include read-only memory (ROM) for storing micro-code. While the example memory sub-system includes a controller, in another embodiment of the present disclosure, a memory sub-system does not include a controller, and can instead rely upon external control (e.g., provided by an external host, or by a processor or controller separate from the memory sub-system).

In general, the controller can receive commands or operations from the host system and can convert the commands or operations into instructions or appropriate commands to achieve the desired access to the memory devices. The controller can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices. The controller can further include host interface circuitry to communicate with the host system via the physical host interface. The host interface circuitry can convert the commands received from the host system into command instructions to access the memory devices as well as convert responses associated with the memory devices into information for the host system.

The memory sub-system can also include additional circuitry or components that are not illustrated. In some embodiments, the memory sub-system can include a cache or buffer (e.g., DRAM) and address circuitry (e.g., a row decoder and a column decoder) that can receive an address from the controller and decode the address to access the memory devices.

In some embodiments, the memory devices include local media controllers that operate in conjunction with the memory sub-system controller to execute operations on one or more memory cells of the memory devices. An external controller (e.g., memory sub-system controller) can externally manage the memory device (e.g., perform media management operations on the memory device). In some embodiments, a memory device is a managed memory device, which is a raw memory device combined with a local media controller for media management within the same memory device package. An example of a managed memory device is a managed NAND (MNAND) device.

The controller or a memory device can include a storage manager configured to implement storage functions discussed above. In some embodiments, the controller in the memory sub-system includes at least a portion of the storage manager. In other embodiments, or in combination, the controller or the processing device in the host system includes at least a portion of the storage manager. For example, the controller, the controller, or the processing device can include logic circuitry implementing the storage manager. For example, the controller, or the processing device (processor) of the host system, can be configured to execute instructions stored in memory for performing the operations of the storage manager described herein. In some embodiments, the storage manager is implemented in an integrated circuit chip disposed in the memory sub-system. In other embodiments, the storage manager can be part of the firmware of the memory sub-system, an operating system of the host system, a device driver, or an application, or any combination therein.

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system’s registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
determining first data representative of a nominal conductance voltage curve of memristors having fabrication process variations;
identifying, based on the first data, a programming voltage list having a predetermined number of programming voltages; and
generating second data representative of a quantized model based on replacing, in an artificial neural network model, first weights in the artificial neural network model with indexes identifying programming voltages in the programming voltage list
.

2. The method of claim 1, wherein the method further comprises:
programming the memristors according to the indexes to implement the first weights;
evaluating an accuracy level of the quantized model based on the memristors being programmed according to the indexes; and
adjusting the programming voltage list to increase the accuracy level; and
wherein the identifying of the programming voltage list includes:
identifying a representative weight list having representative weights of the predetermined number;
mapping, based on a linear mapping, the representative weight list to nominal conductance values; and
determining, using the first data representative of the nominal conductance voltage curve, the programming voltage list from the nominal conductance values.

3. The method of claim 2, wherein the replacing of the first weights with the indexes includes:
identifying, for each of the first weights, a closest representative weight in the representative weight list.

4. The method of claim 3, wherein the adjusting of the programming voltage list includes changing the representative weight list.

5. The method of claim 4, wherein the changing of the representative weight list including changing spacing of adjacent representative weights in a weight space.

6. The method of claim 4, wherein the adjusting of the programming voltage list includes adjusting the linear mapping.

7. The method of claim 6, wherein the evaluating of the accuracy level of the quantized model includes:
computing, using the memristors, first outputs of the quantized model responding to a set of inputs;
computing second outputs of the artificial neural network model responding to the set of inputs; and
comparing the first outputs and the second outputs.

8. The method of claim 7, wherein the second outputs are computed based on implementing the first weights using a logic circuit.

9. A device, comprising:
a memory sub-system having a memristor crossbar array;
voltage drivers coupled to the memristor crossbar array;
a circuitry configured to determine a total current in a plurality of bitlines of the memristor crossbar array; and
a logic circuit configured to:
instruct the voltage drivers to apply a same programming voltage to program conductance of memristors in the memristor crossbar array, the memristors having fabrication process variations; and
apply, after programming the memristors using the programming voltage, an input voltage to a plurality of wordlines of the memristor crossbar array.

10. The device of claim 9, wherein the logic circuitry is further configured to:
determine a nominal conductance value of each memristor in the memristor crossbar array based on the total current determined by the circuitry when the input voltage is applied to the plurality of wordlines; and
wherein the circuitry includes a plurality of current detectors configured to measure currents in the plurality of bitlines respectively.

11. The device of claim 10, wherein the circuitry further comprises a plurality of adders configured to sum outputs of the current detectors.

12. The device of claim 9, wherein the circuitry includes:
a circuit configured to collect currents from the plurality of bitlines into a line; and
an analog digital converter configured to measure a magnitude of current in the line as the total current.

13. The device of claim 12, wherein the logic circuit is configured to determine the nominal conductance value from dividing the total current by a count of memristors connected to the plurality of wordlines and the plurality of bitlines.

14. The device of claim 12, wherein the circuitry includes:
a plurality of current detectors configured to measure currents in the plurality of bitlines respectively during an operation of multiplication and accumulation involving weights implemented via conductance values of the memristors.

15. A system, comprising:
a memristor crossbar array configured to perform multiplication and accumulation operations based on weights represented by conductance values of memristors in the memristor crossbar array, the memristors having fabrication process variations;
at least one processor configured to:
identify, based on first data representative of a nominal conductance voltage curve of the memristors, a first list having a predetermined number of programming voltages;
generate second data representative of a quantized model based on replacing, in an artificial neural network model, first weights in the artificial neural network model with indexes identifying programming voltages selected from the first list to implement the first weights; and
program the memristors according to the indexes to implement the first weights.

16. The system of claim 15, further comprising:
a logical circuit configured to perform multiplication and accumulation operations on the first weights without quantization;
wherein the second outputs are generated using the logical circuit; and
wherein the processor is further configured to:
generate first outputs of the quantized model based on the memristor crossbar array performing multiplication and accumulation operations on the first weights; and
compare the first outputs with second outputs of the artificial neural network model to evaluate an accuracy level of the quantized model.

17. The system of claim 16, further comprising:
a circuitry configured to measure the nominal conductance voltage curve of the memristors.

18. The system of claim 17, wherein the at least one processor is further configured to:
adjust the first list to reduce or minimize differences between the first outputs and the second outputs.

19. The system of claim 18, wherein the at least one processor is further configured to:
identify a second list having representative weights of the predetermined number; and
map, based on a linear mapping, the representative weights in the second list to a third list of nominal conductance values of the predetermined number; and
wherein the programming voltages in the first list are determined according to the nominal conductance voltage curve from the nominal conductance values in the third list.

20. The system of claim 19, wherein the at least one processor is further configured to replace the first weights with the indexes based on rounding up each of the first weights to a closest representative weight in the second list.
